(19) United States
(12) Patent Application Publication
(10) Pub. No.: US 2018/0174481 A1
(43) Pub. Date: Jun. 21, 2018

(54) Child Handwashing Instruction Assembly

(71) Applicant: Olga Stankovich, Irvine, CA (US)

(72) Inventor: Olga Stankovich, Irvine, CA (US)

(21) Appl. No.: 15/379,617

(22) Filed: Dec. 15, 2016

(51) Int. Cl. G09B 19/00; G09B 5/04; A63H 3/00

(52) U.S. Cl. CPC G09B 19/0076; A63H 3/003; G09B 5/04

(57) ABSTRACT

A child hand washing instruction assembly includes a housing and a control circuit mounted in the housing. A motion sensor is mounted on the housing and faces forward thereof. The motion sensor is electrically coupled to the control circuit. A sound emitter is mounted on the housing and is electrically coupled to the control circuit. A memory circuit is mounted in the housing and is electrically coupled to the control circuit. The memory circuit has a pre-recorded message thereon. A power source is electrically coupled to the control circuit. The control circuit audibly plays the pre-recorded message with the sound emitter when the motion sensor detects motion.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to child hand washing timing systems and more particularly pertains to a new child hand washing timing system for ensuring that a child washes their hands for a predetermined amount of time.

### BRIEF SUMMARY OF THE INVENTION

An embodiment of the disclosure meets the needs presented above by generally comprising a housing and a control circuit is mounted in the housing. A motion sensor is mounted on the housing and faces forward thereof. The motion sensor is electrically coupled to the control circuit. A sound emitter is mounted on the housing and is electrically coupled to the control circuit. A memory circuit is mounted in the housing and is electrically coupled to the control circuit. The memory circuit has a pre-recorded message thereon. A power source is electrically coupled to the control circuit. The control circuit audibly plays the pre-recorded message with the sound emitter when the motion sensor detects motion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a child hand washing instruction assembly according to an embodiment of the disclosure.

FIG. 2 is a back view of an embodiment of the disclosure.

FIG. 3 is a front view of an embodiment of the disclosure.

FIG. 4 is a top view of an embodiment of the disclosure.

FIG. 5 is a schematic view of an embodiment of the disclosure.

FIG. 6 is a schematic view of an electronic message of an embodiment of the disclosure.

### DETAILED DESCRIPTION OF THE INVENTION

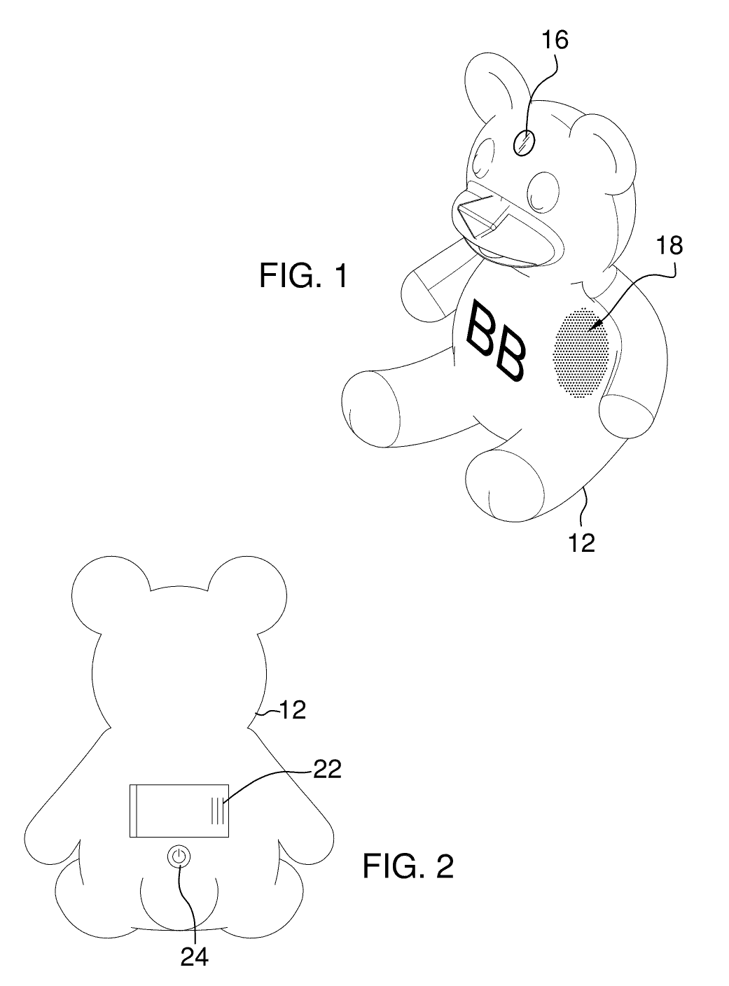

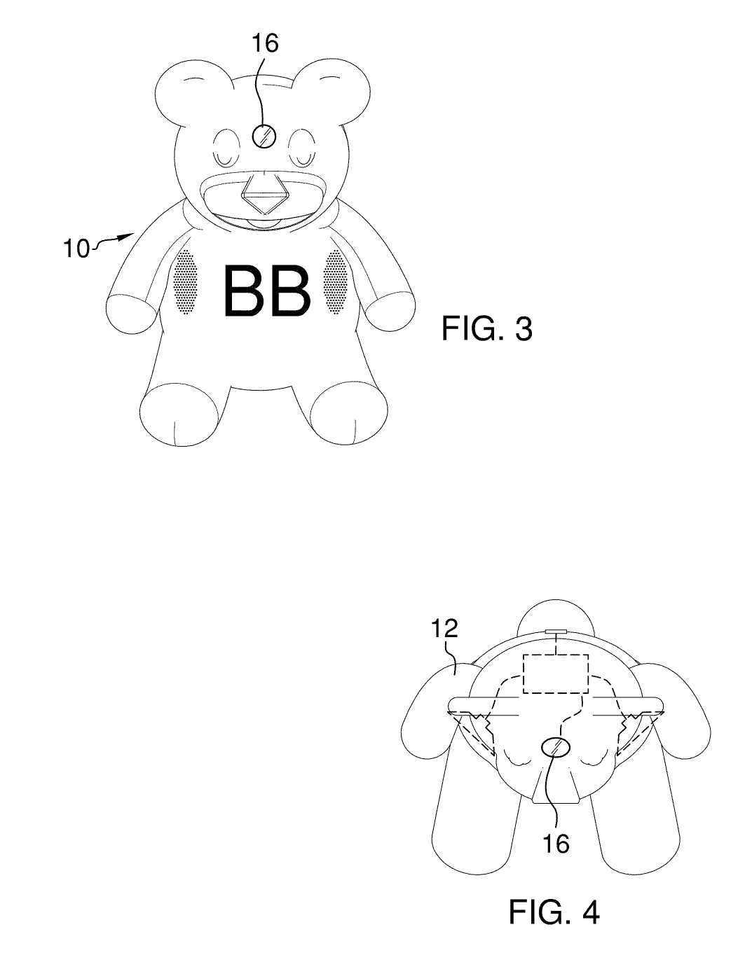

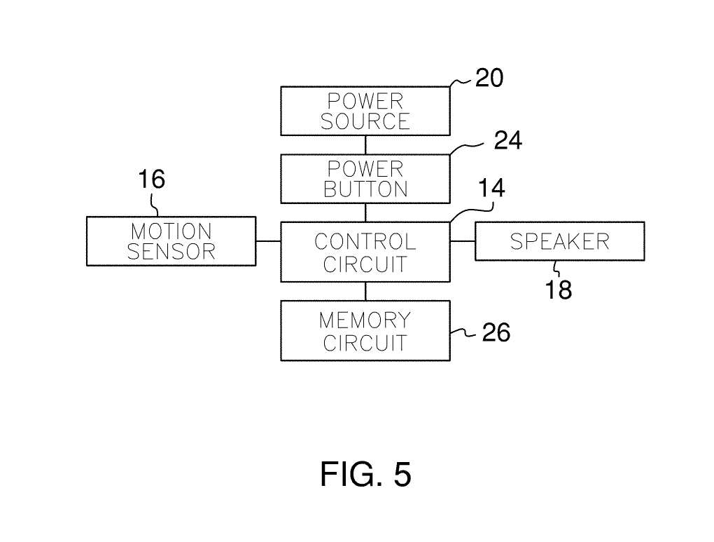

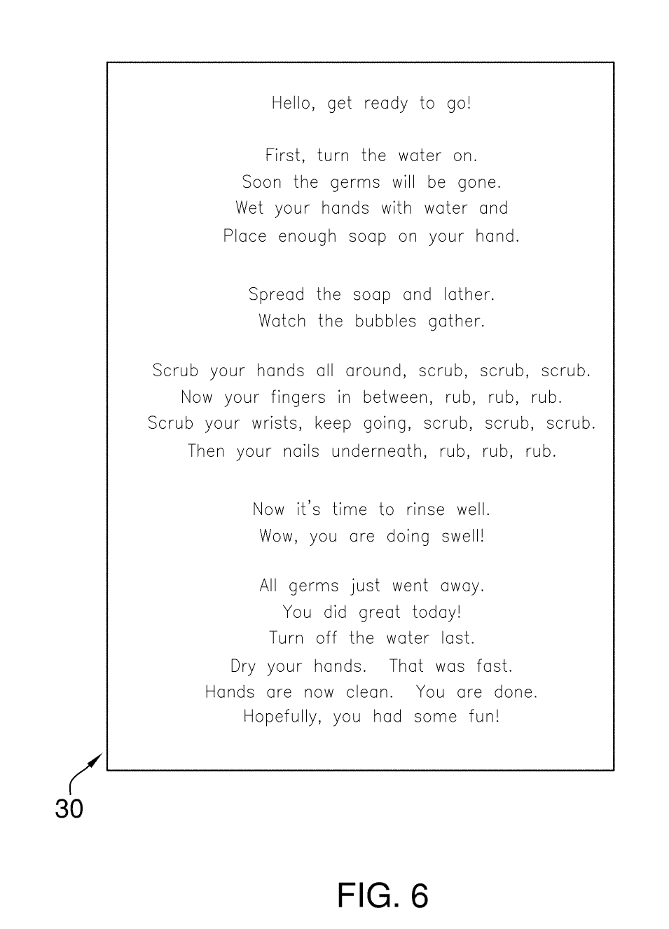

With reference now to the drawings, and in particular to FIGS. 1 through 6 thereof, a new child hand washing timing system embodying the principles and concepts of an embodiment of the disclosure and generally designated by the reference numeral 10 will be described.

As best illustrated in FIGS. 1 through 6, the child hand washing instruction assembly 10 generally comprises a housing 12. The housing 12 may have any shape that is pleasing and entertaining for a child such as toys, cartoon characters, animals and the like. In particular, the housing 12 may have a shape to resemble a teddy bear.

A control circuit 14 is mounted in the housing 12 and a motion sensor 16 is mounted on the housing 12 and faces forward thereof. The motion sensor 16 may be placed on a head of the teddy bear and the motion sensor 16 is electrically coupled to the control circuit 14. A sound emitter 18, or speaker, for emitting audible sound is mounted on the housing 12 and is electrically coupled to the control circuit 14. A power source 20 is electrically coupled to the control circuit 14. The power source 20 may comprise one or more batteries positioned within said housing 12 and accessible through an access panel 22 on the housing 12. Alternatively, the power source 20 may include a power cord electrically coupled to the control circuit 14 and a power outlet into which the power cord is plugged. A power button 24 is electrically coupled to the control circuit 14 and may be actuated to turn the control circuit 14 on or off.

A memory circuit 26 is mounted in the housing 12 and is electrically coupled to the control circuit 14. The memory circuit 26 has a pre-recorded message thereon. The pre-recorded message 30 has a length of greater than 30 seconds and less than 90 seconds and more particularly may have a length of between 50 seconds and 70 seconds. The pre-recorded message 30 may comprise a poem or story which discusses the importance of cleaning ones hands or may simply provide entertainment to encourage a child to remain at a sink and wash their hands. The control circuit 14 audibly plays the pre-recorded message 30 with the sound emitter 18 when the motion sensor 16 detects motion.

In use, the housing 12 is positioned adjacent to a sink that a child will use to wash their hands. When a child approaches the sink, the motion sensor 16 will detect the child and the control circuit 14 will begin the pre-recorded message 30. The child will understand that they must wash their hands continuously while the pre-recorded message 30 is being played. This will ensure that the child will wash their hand for a pre-selected amount of time which will typically be at least 60 seconds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A child hand washing timing assembly configured to encourage a child to wash their hands for a preselected amount of time, said assembly comprising:
a housing;
a control circuit being mounted in said housing;
a motion sensor being mounted on said housing and facing forward thereof, said motion sensor being electrically coupled to said control circuit;
a sound emitter being mounted on said housing and being electrically coupled to said control circuit;
a memory circuit being mounted in said housing and being electrically coupled to said control circuit, said memory circuit having a pre-recorded message thereon;
a power source being electrically coupled to said control circuit; and
said control circuit audibly playing said pre-recorded message with said sound emitter when said motion sensor detects motion.

2. The child hand washing timing assembly according to claim 1, wherein said housing has a shape to resemble a teddy bear.

3. The child hand washing timing assembly according to claim 1, wherein said pre-recorded message has a length of greater than 30 seconds and less than 90 seconds.

4. The child hand washing timing assembly according to claim 3, wherein said pre-recorded message comprises a poem.

5. The child hand washing timing assembly according to claim 1, further including a power button is electrically coupled to said control circuit, said power button being actuated to turn said control circuit on or off.

6. A child hand washing timing assembly configured to encourage a child to wash their hands for a preselected amount of time, said assembly comprising:
a housing, said housing having a shape to resemble a teddy bear;
a control circuit being mounted in said housing;
a motion sensor being mounted on said housing and facing forward thereof, said motion sensor being electrically coupled to said control circuit;
a sound emitter being mounted on said housing and being electrically coupled to said control circuit;
a memory circuit being mounted in said housing and being electrically coupled to said control circuit, said memory circuit having a pre-recorded message thereon, said pre-recorded message having a length of greater than 30 seconds and less than 90 seconds, said pre-recorded message comprising a poem;
a power source being electrically coupled to said control circuit;
said control circuit audibly playing said pre-recorded message with said sound emitter when said motion sensor detects motion; and
a power button is electrically coupled to said control circuit, said power button being actuated to turn said control circuit on or off.
